(19) United States
(12) Patent Application Publication
(10) Pub. No.: US 2009/0047984 A1
(43) Pub. Date: Feb. 19, 2009

(54) Method for selecting a serving carrier in a multi-carrier system

(76) Inventors: Sridhar Gollamudi, Morris Plains, NJ (US); Robert Atmaram Soni, Randolph, NJ (US)

Correspondence Address: HARNESS, DICKEY & PIERCE, P.L.C., P.O. BOX 8910, RESTON, VA, 20195, US

(21) Appl. No.: 12/216,005

(22) Filed: Jun. 27, 2008

Related U.S. Application Data
(60) Provisional application No. 60/965,000, filed on Aug. 16, 2007.

(51) Int. Cl. H04Q 7/20; H04B 7/00

(52) U.S. Cl. 455/513; 455/509

(57) ABSTRACT

One of a plurality of carrier frequencies may be selected as a serving carrier for an uplink transmission based on at least one of a mobile velocity and loading conditions of the plurality of carrier frequencies. Selection of the serving carrier favors a carrier frequency having a smaller loading than at least one other carrier frequency based on the loading conditions. Also, selection of the serving carrier favors a lower frequency carrier for a higher mobile velocity and favors a higher frequency carrier for a lower mobile velocity based on the mobile velocity.

### PRIORITY STATEMENT

This U.S. non-provisional application claims priority under 35 U.S.C. §119(e) to U.S. Provisional Application No. 60/965000, filed Aug. 16, 2007, in the United States Patent and Trademark Office, the entire contents of which are incorporated herein by reference.

### BACKGROUND

A multi-carrier wireless communications system includes a network and a mobile. The network includes a plurality of base stations, where the mobile within a cell of a base station may communicate on more than one carrier frequency. The base station has at least one transmitter and one receiver for the multiple carrier frequencies. For example, a network that uses High-Speed Packet Access (HSPA) may communicate on both the 850 Megahertz (MHz) and 1900 Mhz carrier frequencies. The mobile may be capable or receiving and transmitting signals on any of the two or more frequency carriers, as configured by the network.

The multi-carrier wireless communications system is designed to simultaneously use multiple carrier frequencies for the same user to increase the transmission data rates for certain kinds of transmissions, such as downlink data transmissions. Other kinds of transmissions, such as transmissions on the uplink and some signaling channels, may be configured to use only one carrier frequency. Reasons for using only one carrier frequency on the uplink may for instance include an inability of the mobile to transmit simultaneously on several carriers or because an increased data rate is not required based on the current traffic. In such a situation, the network may choose one of a plurality of carrier frequencies, called the serving carrier, for uplink transmissions.

### SUMMARY

Example embodiments relate to method of selecting a serving carrier in a multi-carrier system.

In one example embodiment, one of a plurality of carrier frequencies is selected as a serving carrier for an uplink transmission based on at least one of a mobile velocity and loading conditions of the plurality of carrier frequencies.

According to an example embodiment, a carrier frequency on which a random access channel (RACH) was transmitted for initial access to a network is used as an initial serving carrier for a mobile. The serving carrier is changed if the selecting determines a different serving carrier, the changing indicated to the mobile using radio resource control (RRC) signaling.

An example embodiment may include receiving radio resource control (RRC) measurements from a mobile, wherein the selecting is based on the RRC measurements and at least one of the mobile velocity and the loading conditions.

According to an example embodiment, the selecting favors a carrier frequency having at least one of a lower path loss plus shadowing and a higher signal-to-interference-noise-ratio (SINR) than at least one other carrier frequency based on the RRC measurements.

In one embodiment, the selecting favors a carrier frequency having a smaller loading than at least one other carrier frequency based on the loading conditions.

In another embodiment, the selecting favors a lower frequency carrier for a higher mobile velocity and favors a higher frequency carrier for a lower mobile velocity based on the mobile velocity.

According to an example embodiment, selecting a serving carrier includes mapping the loading conditions on a first carrier frequency, the loading conditions on a second carrier frequency and the mobile velocity for any given time to a threshold value, and/or determining a difference between a downlink signal-to-interference-noise-ratio (SINR) of the first carrier frequency and the second carrier frequency. The receiving includes receiving the downlink SINR of the first carrier frequency and the second carrier frequency from the mobile. The selecting further includes selecting one of the first carrier frequency and the second carrier frequency based on the determined SINR difference and the threshold value.

An embodiment further includes comparing the determined SINR difference to the threshold value, wherein the selecting includes selecting the first carrier frequency if the determined SINR difference is larger than the threshold value and selecting the second carrier frequency if the determined SINR difference is less than or equal to the threshold value.

According to another embodiment, selecting a serving carrier includes mapping the loading conditions on each of the plurality of carrier frequencies and the mobile velocity to a plurality of offset values. The selecting includes selecting one of the plurality of carrier frequencies based on the plurality of offset values.

An embodiment further includes adjusting each of the corresponding one of the plurality of offset values based on a downlink signal-to-interference-noise-ratio (SINR) of each of the plurality of carrier frequencies. The receiving includes receiving the downlink SINR of each of the plurality of carrier frequencies from the mobile. The selecting includes selecting the carrier frequency corresponding to the largest offset value.

### BRIEF DESCRIPTION

Example embodiments will become more fully understood from the detailed description given herein below and the accompanying drawings, wherein like elements are represented by like reference numerals, which are given by way of illustration only and thus are not limiting of the present invention, and wherein:

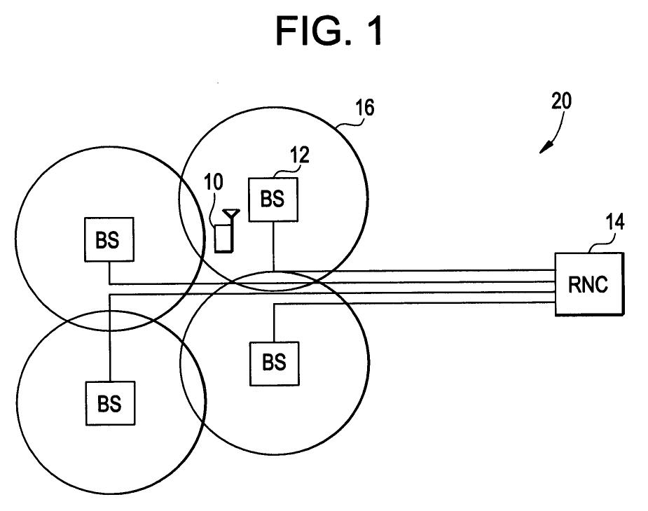

FIG. 1 illustrates a portion of a multiple carrier wireless telecommunications system according to an example embodiment;

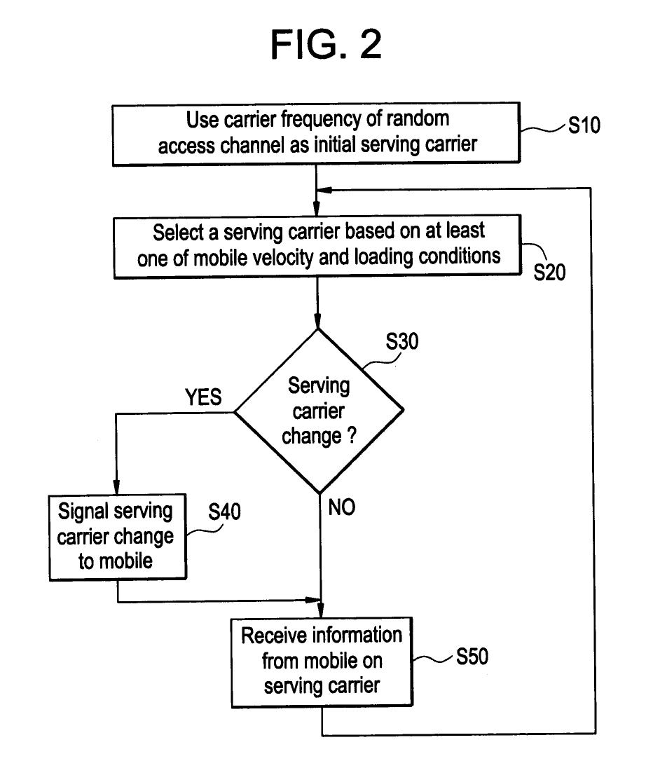

FIG. 2 illustrates a method for selecting a serving carrier according to an example embodiment;

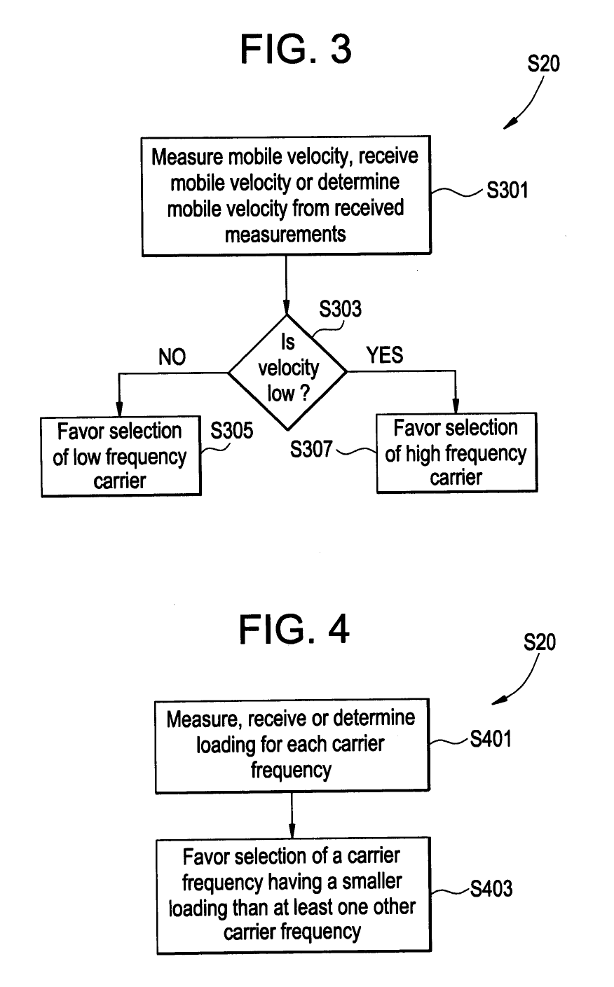

FIG. 3 illustrates an embodiment of step S20 in the method in FIG. 2 in which the serving carrier is selected based on at least mobile velocity;

FIG. 4 illustrates an embodiment of step S20 in the method in FIG. 2 in which the serving carrier is selected based on at least loading for each carrier frequency;

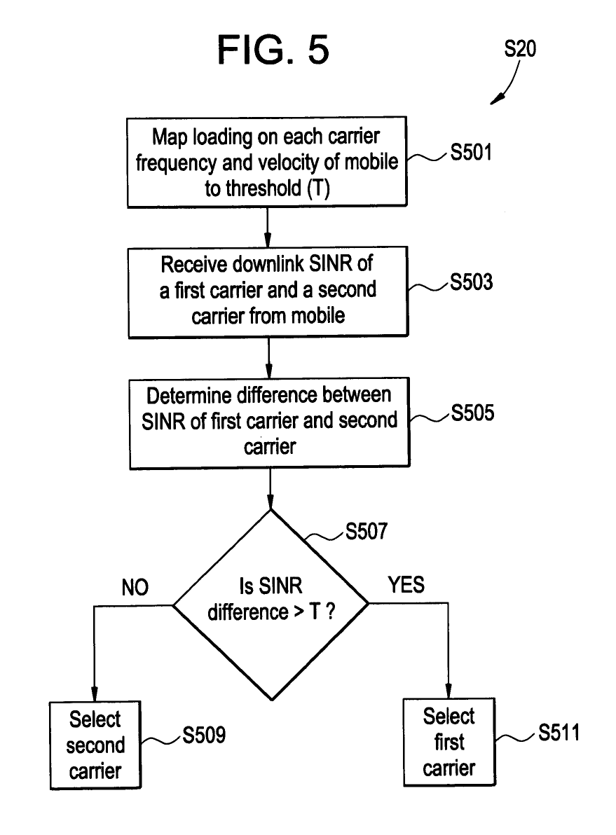

FIG. 5 illustrates an embodiment of step S20 in the method in FIG. 2 in which the serving carrier is selected based on at least mobile velocity, loading for each carrier frequency and downlink measurements received from the mobile; and

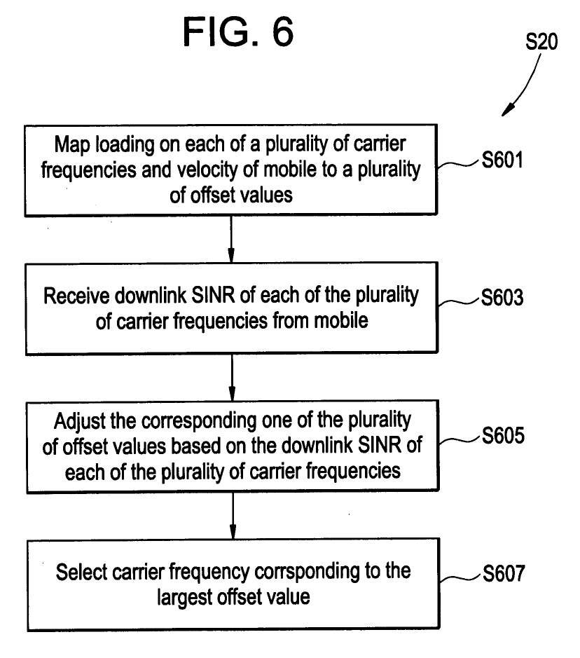

FIG. 6 illustrates an embodiment of step S20 in the method in FIG. 2 in which the serving carrier is selected based on at least mobile velocity, loading for each carrier frequency and downlink measurements received from the mobile.

### DETAILED DESCRIPTION

Various example embodiments will now be described more fully with reference to the accompanying drawings.

Specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent”, etc.).

Unless otherwise defined, all terms (including technical and scientific terms) used herein have the same meaning as commonly understood by one of ordinary skill in the art to which example embodiments belongs. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

It should also be noted that in some alternative implementations, the functions/acts noted may occur out of the order noted in the FIGS. For example, two FIGS. shown in succession may in fact be executed substantially concurrently or may sometimes be executed in the reverse order, depending upon the functionality/acts involved.

As used herein, the term “mobile” may be considered synonymous to, and may hereafter be occasionally referred to, as a mobile unit, mobile station, mobile user, user equipment (UE), subscriber, user, remote station, access terminal, receiver, etc., and may describe a remote user of wireless resources in a wireless communication network. The term “base station” may be considered synonymous to and/or referred to as a base transceiver station (BTS), base station, NodeB, etc. and may describe equipment that provides data and/or voice connectivity between a network and one or more users.

As is well-known in the art, each of a mobile and a base station may have transmission and reception capabilities. Transmission from the base station to the mobile is referred to as downlink or forward link communication. Transmission from the mobile to the base station is referred to as uplink or reverse link communication.

FIG. 1 illustrates a portion of a multiple carrier wireless telecommunications system according to an example embodiment. As shown, the wireless telecommunications system includes a mobile 10 and a network 20. For the sake of clarity, only one mobile 10 is shown. The network 20 may include one or more base stations 12 and a radio network controller (RNC) 14.

The RNC 14 may be communicatively coupled to the one or more base stations 12 by any of a variety of wired and/or wireless links. Signals passed between the RNC 14 and the one or more base stations 12 may pass through one or more other devices (not shown), such as, routers, switches, networks or the like. The RNC 14 may also serve as an interface between the mobile 10, and other wireless telecommunications system, GPRS Service Nodes (SGSNs), Gateways (GGSNs), or any other wireless or terrestrial network or network device. Further, the RNC 14 may perform other tasks such as switching and/or provisioning services of a mobile switching center (not shown) and/or 3G data network interfaces (not shown).

Each base station 12 is associated with at least one cell 16. Each cell 16 corresponds to a geographic area having a given radius. The base station 12 supports transmission and reception over multiple carrier frequencies. The carrier frequencies may be in a same band or different bands. A plurality of mobiles may be located in the cell at any one time. The mobile 10 may listen to more than one carrier frequency of the base station 12 on the downlink, but only transmit on one carrier frequency of the base station 12 on the uplink. The carrier frequency over which the mobile 10 transmits on the uplink is referred to as the serving carrier for the mobile 10.

Accordingly, the serving carrier may provide signaling on the downlink to support the uplink traffic of the mobile 10; but otherwise, downlink communication to the mobile 10 may be over any one or more of the carrier frequencies. For instance, in an evolved High-Speed Packet Access (HSPA) system, all uplink control and data channels such as Dedicated Physical Control Channel (DPCCH), Dedicated Physical Data Channel (DPDCH), Enhanced Dedicated Physical Data Channel (E-DPDCH), Enhanced Dedicated Physical Control Channel(E-DPCCH) and High-Speed Dedicated Physical Control Channel (HS-DPCCH) may be transmitted over the serving carrier. If there are any single carrier channels on the downlink, these channels may also be carried on the serving carrier.

The Fractional Dedicated Physical Channel (F-DPDCH) or the associated Dedicated Physical Channel (DPCH) may also be transmitted over the serving carrier. To optimize performance for both the mobile 10 and the network 20, selection of the serving carrier for the mobile 10 may take into account at least one of loading conditions on each carrier frequency and/or mobile velocity, as further shown in FIG. 2.

FIG. 2 illustrates a method for selecting a serving carrier according to an example embodiment. The method of FIG. 2 will be described in relation to, but not limited to, the wireless telecommunications system of FIG. 1. Furthermore, while FIG. 2 describes the method with respect to a single mobile, it will be appreciated that the method may be performed for a plurality of mobiles. Further, the method may be performed in parallel for the plurality of mobiles.

As shown in step S10, a carrier frequency on which a random access channel (RACH) is transmitted for initial access to the network 20 is used as an initial serving carrier for the mobile 10. Next, in step S20, one of a plurality of carrier frequencies is selected as a serving carrier by the RNC 14 for an uplink transmission based on at least one of a mobile velocity and loading conditions of the plurality of carrier frequencies. Next, at step S30, the current serving carrier and the selected serving carrier from step S20 are compared by the RNC 14. If the serving carriers are different, in step S40, the mobile 10 is signaled by the RNC 14 through the base station 12 using Radio Resource Control (RRC) signaling to change to the selected serving carrier of step S20. Next, the RNC 14 proceeds to step S50. If the serving carriers are the same in step S30, the RNC 14 skips step S40 and proceeds directly to step S50. In step S50, the RNC 14 receives information from the mobile 10 on the serving carrier through the base station 12. Such information may include voice and data communications. Optionally, the RNC 14 may also send information to the mobile 10 on the serving carrier. Next, the process may be repeated by flowing to step S20 to determine whether the optimal serving carrier has changed.

FIG. 3 illustrates an embodiment of step S20 in the method in FIG. 2 in which the serving carrier is selected based on at least mobile velocity. In step S301, at least one of measuring a velocity of the mobile 10, receiving the velocity of the mobile 10 and determining the velocity of the mobile 10 based on received measurements is used to determine the mobile velocity by the RNC 14 via the base station 12. In step S303, the RNC 14 determines whether the mobile velocity is low or high according to a threshold. If the mobile velocity is high, the RNC 14 favors selecting a lower frequency carrier in step S305. If the mobile velocity is low, the RNC 14 favors selecting a higher frequency carrier in step S307. Favoring the selection of a lower carrier frequency for a high mobile velocity may lead to better pathloss characteristics than a higher carrier frequency.

FIG. 4 illustrates an embodiment of step S20 in the method in FIG. 2 in which the serving carrier is selected based on at least loading for each carrier frequency. In step S401, the base station 12 and/or RNC 14 receives, measures and/or determines the loading for each carrier frequency. In step S403, the base station 12 and/or RNC 14 favors selecting a carrier frequency having a smaller loading than at least one other carrier frequency. Favoring the selection of a carrier frequency having a smaller loading may lead to less congestion in the network 20 and thus at least better response times for the mobile 10.

The loading on each carrier frequency, as described in FIG. 4 and the mobile velocity, as described in FIG. 3 may also be considered jointly in selecting a serving carrier. In addition, to the mobile velocity and the loading on each carrier frequency, the RNC 14 via the base station 12 may also consider RRC measurements received from the mobile 10 in favoring the selection of a serving carrier. For instance, a carrier frequency having at least one of a lower path loss plus shadowing and a higher signal-to-interference-noise-ratio (SINR) than at least one other carrier frequency based on the RRC measurements is favored in selecting a serving carrier. Thus, the mobile velocity, loading on each carrier frequency, and RRC measurements may be considered singly or any combination thereof to select a serving carrier. Combinations may include manipulating the mobile velocity, loading on each carrier frequency, and RRC measurements, along with other data, according to any commonly known techniques, for example, using weights, ratios, differences, etc. of the data. FIGS. 5 and 6, as explained below, provide such examples.

FIG. 5 illustrates an embodiment of step S20 in the method in FIG. 2 in which the serving carrier is selected based on at least mobile velocity, loading for each carrier frequency and downlink measurements received from the mobile.

In step S501, the base station 12 and/or RNC 14 map the loading conditions on a first carrier frequency, the loading conditions on a second carrier frequency and the mobile velocity for any given time to a threshold value. In step S503, the RNC 14 via the base station 12 receives a downlink SINR of the first carrier frequency and the second carrier frequency from the mobile 10. In step S505, the RNC 14 determines a difference between the downlink SINR of the first carrier frequency and the second carrier frequency. Next, the RNC 14 selects one of the first carrier frequency and the second carrier frequency based on the determined SINR difference and the threshold value. For instance, in step S507, the RNC 14 compares the determined SINR difference to the threshold value. In step S509, the second carrier frequency is selected by the RNC 14 if the determined SINR difference is less than or equal to the threshold value. In Step S511, the first carrier frequency is selected by the RNC 14 if the determined SINR difference is larger than the threshold value.

FIG. 6 illustrates an embodiment of step S20 in the method in FIG. 2 in which the serving carrier is selected based on at least mobile velocity, loading for each carrier frequency and downlink measurements received from the mobile.

In step S601, the base station 12 and/or RNC 14 map the loading on each of the plurality of carrier frequencies and the mobile velocity to a plurality of offset values. In step S603, the RNC 14 receives a downlink SINR of each of the plurality of carrier frequencies from the mobile 10 through the base station 12. In step S605, the RNC 14 adjusts each of the corresponding one of the plurality of offset values based on the downlink SINR of each of the plurality of carrier frequencies. Each corresponding offset may be adjusted in various ways based on the downlink SINR, including, for example, adding (in a weighted or non-weighted fashion) the downlink SINR to the corresponding offset. Next, the RNC 14 selects one of the plurality of carrier frequencies as the serving carrier. For instance, in step S607, the RNC 14 selects the carrier frequency corresponding to the largest offset value.

Although the threshold above is described as being based on the loading conditions on a first carrier frequency, the loading conditions on a second carrier frequency and the mobile velocity for any given time to a threshold value, example embodiments are not limited thereto.

Similarly, even though the above plurality of offsets are described as being based on the loading conditions of each of the plurality of carrier frequencies, the mobile velocity and the downlink SINR of each of the plurality of carrier frequencies, example embodiments are not limited thereto.

Accordingly, example embodiments may take into account various factors, thresholds, and offsets, in addition to those described above, in selecting a serving carrier.

According to example embodiments, selection of the optimal serving carrier may result in improvement in the uplink data and voice capacities as well as uplink coverage.

While example embodiments have been described with respect to a single network and a single base station, it will be understood that the serving carrier selection methodologies may be expanded to include frequency carriers from multiple networks and multiple base stations. Applicable networks may include various 3G networks such as HSPA. All of the above function described above may be readily carried out by special or general purpose digital information processing devices acting under appropriate instructions embodied, e.g., in software, firmware, or hardware programming.

While, example embodiments have described the base station as selecting the serving carrier, various other components of the network may also carry out selection of serving carrier, either singly or in combination with other components. For example, the RNC may carry out the selection of serving carrier instead of the base station or alternatively, in conjunction with the base station. Network components may also include the mobile itself.

Example embodiments being thus described, it will be obvious that the same may be varied in many ways. Such variations are not to be regarded as a departure from the invention, and all such modifications are intended to be included within the scope of the invention.

I/We claim:

1. A method for selecting a serving carrier in a multi-carrier system, comprising:
selecting one of a plurality of carrier frequencies as a serving carrier for an uplink transmission based on at least one of a mobile velocity and loading conditions of the plurality of carrier frequencies.

2. The method of claim 1, further comprising:
using a carrier frequency on which a random access channel (RACH) was transmitted for initial access to a network as an initial serving carrier for a mobile; and
changing the serving carrier if the selecting determines a different serving carrier, the changing indicated to the mobile using radio resource control (RRC) signaling.

3. The method of claim 1, further comprising:
receiving radio resource control (RRC) measurements from a mobile, wherein
the selecting is based on the RRC measurements and at least one of the mobile velocity and the loading conditions

4. The method of claim 3, wherein the selecting favors a carrier frequency having at least one of a lower path loss plus shadowing and a higher signal-to-interference-noise-ratio (SINR) than at least one other carrier frequency based on the RRC measurements.

5. The method of claim 1, wherein the selecting favors a carrier frequency having a smaller loading than at least one other carrier frequency based on the loading conditions.

6. The method of claim 1, wherein the selecting favors a lower frequency carrier for a higher mobile velocity and favors a higher frequency carrier for a lower mobile velocity based on the mobile velocity.

7. The method of claim 3, wherein the selecting is based on the RRC measurements, the loading conditions and the mobile velocity.

8. The method of claim 7, further comprising:
mapping the loading conditions on a first carrier frequency, the loading conditions on a second carrier frequency and the mobile velocity for any given time to a threshold value; and
determining a difference between a downlink signal-to-interference-noise-ratio (SINR) of the first carrier frequency and the second carrier frequency, wherein
the receiving includes receiving the downlink SINR of the first carrier frequency and the second carrier frequency from the mobile, and wherein
the selecting includes selecting one of the first carrier frequency and the second carrier frequency based on the determined SINR difference and the threshold value.

9. The method of claim 8, further comprising:
comparing the determined SINR difference to the threshold value, wherein
the selecting includes selecting the first carrier frequency if the determined SINR difference is larger than the threshold value and selecting the second carrier frequency if the determined SINR difference is less than or equal to the threshold value.

10. The method of claim 7, further comprising:
mapping the loading conditions on each of the plurality of carrier frequencies and the mobile velocity to a plurality of offset values, wherein
the selecting includes selecting one of the plurality of carrier frequencies based on the plurality of offset values.

11. The method of claim 10, further comprising:
adjusting each of the corresponding one of the plurality of offset values based on a downlink signal-to-interference-noise-ratio (SINR) of each of the plurality of carrier frequencies, wherein
the receiving includes receiving the downlink SINR of each of the plurality of carrier frequencies from the mobile, and wherein
the selecting includes selecting the carrier frequency corresponding to the largest offset value.

12. The method of claim 3, wherein the selecting is based on the RRC measurements and the loading conditions.

13. The method of claim 12, wherein the selecting favors a carrier frequency having a smaller loading than at least one other carrier frequency based on the loading conditions.

14. The method of claim 12, wherein the selecting favors a carrier frequency having at least one of a lower path loss plus shadowing and a higher signal-to-interference-noise-ratio (SINR) than at least one other carrier frequency based on the RRC measurements.

15. The method of claim 3, wherein the selecting is based on the RRC measurements and the mobile velocity.

16. The method of claim 15, wherein the selecting favors a lower frequency carrier for a higher mobile velocity and favors a higher frequency carrier for a lower mobile velocity based on the mobile velocity.

17. The method of claim 15, wherein the selecting favors a carrier frequency having at least one of a lower path loss, a lower shadowing and a higher signal-to-interference-noise-ratio (SINR) than at least one other carrier frequency based on the RRC measurements.

18. The method of claim 1, wherein the selecting is based on the loading conditions and the mobile velocity.

19. The method of claim 18, wherein the selecting favors a carrier frequency having a smaller loading than at least one other carrier frequency based on the loading conditions.

20. The method of claim 18, wherein the selecting favors a lower frequency carrier for a higher mobile velocity and favors a higher frequency carrier for a lower mobile velocity based on the mobile velocity.
